(19) United States
(12) Patent Application Publication
(10) Pub. No.: US 2005/0092028 A1
(43) Pub. Date: May 5, 2005

(54) Light weight gravity bending ring

(76) Inventor: William Blanc, Brandenburg, KY (US)

Correspondence Address: HARNESS, DICKEY & PIERCE, P.L.C., P.O. BOX 828, BLOOMFIELD HILLS, MI, 48303, US

(21) Appl. No.: 10/702,173

(22) Filed: Nov. 5, 2003

(51) Int. Cl. C03B 23/02

(52) U.S. Cl. 65/291

(57) ABSTRACT

A bending ring for supporting a glass sheet during heating having a pair of longitudinally extending tubular members being generally square shaped and a plurality of traversely extending tubular members also being generally square shaped. The plurality of traversely extending tubular members being fixedly coupled to the pair of longitudinally extending tubular members to form a generally rectangular assembly. A plurality of support brackets are further provided having an extending portion and a face portion. The extending portion positioned adjacent a first side of one of the pair of longitudinally extending tubular members. The face portion abutting a second side of the one of the pair of longitudinally extending tubular members.

### FIELD OF THE INVENTION

The present invention relates to bending rings and, more particularly, relates to a lightweight gravity-bending ring capable of reducing cycle time and manufacturing costs associated with forming vehicle glass.

### BACKGROUND OF THE INVENTION

Glass sheet conveyors and bending apparatus are used in the mass production of curved or bent glass sheets for the automotive industry and other similar applications. In high volume production operations, glass sheets are sequentially advanced along a horizontal forming path upon bending frame members, which are commonly referred to as bending rings. This process includes heating the glass to its softening point within a furnace, bending the glass to the desired shape using one of a number of techniques, and finally controlled cooling of the bent sheet of glass in order to anneal or temper the glass.

The primary processes used for shaping the heat-softened glass are roll forming, press bending, and gravity or sag forming. Briefly, in roll forming, the heated glass is conveyed on top of a series of shaping rolls, or between an upper set and lower set of shaping rolls, which engage the glass for shaping. Press bending involves positioning the glass in the bending apparatus between complementary upper and lower shaping members. The properly oriented sheet is then engaged along its lower marginal edge portions by the lower press member and lifted from the conveyor rolls to be pressed to the precise predetermined curvature between the complementary shaping surfaces of the press members. In gravity forming, the heated glass is allowed to sag into conformity with the bending frame or a series of contoured shaping rollers by the force of gravity.

To be suitable for automotive applications, the flat glass sheets must be shaped to precisely defined curvatures dictated by the shape and outline of the window openings in the vehicle. This glass must meet stringent optical requirements and must free of optical defects and reflective distortion that could interfere with the view through the glass in the viewing area.

During the forming process, the glass sheets are heated to the softening point as they pass through the heating furnace. It is desirable for the glass sheets to be heated as quickly as possible to increase the throughput of the forming system. Therefore, heat must be imparted upon the glass sheets as efficiently as possible to minimize the heating cost and cycle time.

Conventional bending rings used to support these glass sheets are typically comprised of durable, yet heavy, support members. These support members are typically arranged in a rectangular pattern and include a plurality of cross members to reinforce the bending ring geometry. The bending ring is carried by a conveyor system through the furnace and bending stations. Typically, as any one time, a plurality of bending rings are used in each furnace to support an equal number of glass sheets. Unfortunately, conventional bending rings are heavy and difficult to handle due to their size. By way of example, conventional bending rings are commonly made of ¼″ or 3/16″ angled members made of steel (also known as angle iron). Once assembled, it is not uncommon for these conventional bending rings used to support a standard sized vehicle windshield to weigh in excess of 100 lbs.

It should be understood by one skilled in the art that such bending ring mass further inhibits the aforementioned and desirable rapid heating of the glass. That is, due to the mass of the conventional bending ring, the bending ring has a high thermal capacity and requires enormous heat input to raise its temperature to that of the furnace. As can be appreciated, it is desirable to heat the glass sheet to its softening point and, therefore, any heat energy used to heat the bending ring is considered wasted.

However, despite the above, any preferred bending ring must be rigid enough to support the glass sheet thereon. Vehicle glass has become progressively thinner over recent years and the shapes have become progressively more complex. Often times, the tolerances of these complex shapes are quite small. Therefore, any bending ring used for these applications must further remain rigid to achieve these tolerances.

Accordingly, there exists a need in the relevant art to provide a bending ring that is lightweight to enable easy handling and further has a reduced mass to minimize the amount of thermal energy needed to raise the temperature thereof. Furthermore, there exists a need in the relevant art to provide a bending ring that is capable of remaining rigid during the forming process to achieve the tight tolerances now required in the industry. Still further, there exists a need in the relevant art to overcome the disadvantages of the prior art.

### SUMMARY OF THE INVENTION

According to the principles of the present invention, a lightweight bending ring and frame assembly is provided for supporting a glass sheet during heating having advantageous construction. The bending ring and frame assembly includes a pair of longitudinally extending tubular members being generally square shaped and a plurality of traversely extending tubular members also being generally square shaped. The plurality of traversely extending tubular members are fixedly coupled to the pair of longitudinally extending tubular members to form a generally rectangular assembly. A plurality of support brackets are further provided having an extending portion and a face portion. The extending portion is positioned adjacent a first side of one of the pair of longitudinally extending tubular members. The face portion abuts a second side of the one of the pair of longitudinally extending tubular members.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawing, wherein:

FIG. 1 is a perspective view illustrating the bending ring according to the principles of the present invention.

### DETAILED DESCRIPTION OF THE PREFERRED EMBODIMENT

The following description of the preferred embodiment is merely exemplary in nature and is in no way intended to limit the invention, its application, or uses.

Referring to the figure, a gravity bending ring and frame assembly 10, hereinafter collectively referred to as gravity bending ring 10, is provided for supporting and transporting a glass sheet through a furnace station, a forming station, and a cooling station. Gravity bending ring 10 employs a lightweight rigid construction, which minimizes the thermal capacity of the bending ring and therefore increases heating efficiency of the glass sheet and decreases manufacturing cycle time. That is, gravity bending ring 10 is able to achieve the structural rigidity necessary to accurately form a glass sheet. Unlike conventional bending rings that used heavy gauge angle iron to achieve the necessary rigidity, the present invention achieves the necessary rigidity through the use of lighter gauge square shaped tube members. The thinner wall thickness of the square members provides a lighter bending ring, while the square shape provides the necessary rigidity.

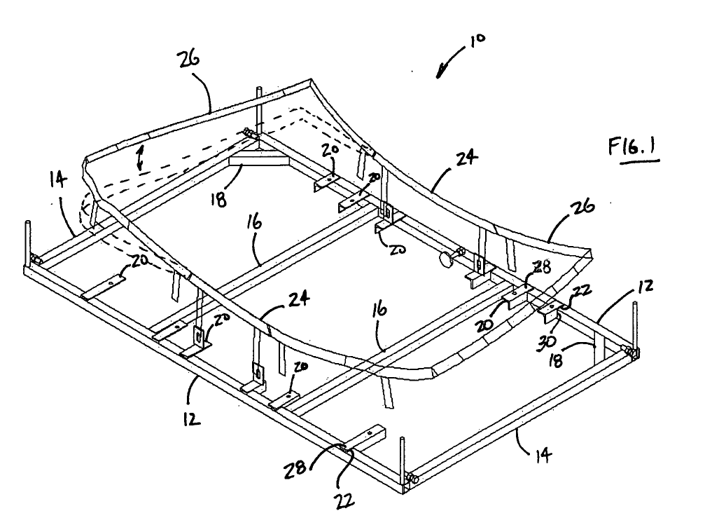

As best seen in FIG. 1, gravity bending ring 10 is comprised of a pair of longitudinally extending members 12 and a corresponding pair of traversely extending members 14. Longitudinally extending members 12 and traversely extending members 14 are joined together to form a generally rectangular frame via welding, fastening, or other conventional method. Longitudinally extending members 12 and traversely extending members 14 are formed of square-shaped tubular members. Preferably, although non-limiting, these square-shaped tubular members are made of 304 stainless steel and measure approximately 1.25″×1.25″ as an exterior dimension with a wall thickness of approximately 1/16″.

Gravity bending ring 10 further preferably comprises a pair of cross support members 16 joined to longitudinally extending members 12 for improved cross-frame support. A plurality of gussets 18 may be disposed in the corners of longitudinally extending members 12 and traversely extending members 14 for additional structural reinforcement and rigidity. The pair of cross support members 16 and the plurality of gussets 18 are similarly made of the aforementioned square-shaped tubular members to provide a lightweight and rigid reinforcement.

A plurality of bracket members 20 are mounted to at least one of the pair of longitudinally extending members 12. The plurality of bracket members 20 are adapted to provide a mounting connection for a pair of central stationary members 24 and a pair of outboard movable members 26. Each of the pair of outboard movable members 26 are pivotally coupled by conventional means (not shown) to longitudinally extending members 12 to permit the actuation of outboard movable members 26 and the subsequent forming of the softened glass.

Each of the plurality of bracket members 20 is made of angled stainless steel having notched ends 22. Notched ends 22 include an extending portion 28 and a facing portion 30. Extending portion 28 is adapted to lay adjacent a side of longitudinally extending member 12 and facing portion 30 is adapted to abut a side of longitudinally extending member 12. Each of the plurality of bracket members 20 may be welded to longitudinally extending members 12 along notched ends 22, which provides additional welding surfaces for an improved connection.

In comparison to prior art bending rings that often weigh in excess of 100 pounds and require two workers to handle, gravity bending ring 10 of the present invention has been found to weigh substantially less than the conventional 100 pounds and, more particularly, about 70 pounds. Additionally, it has been found that these rings can be easily managed by a single worker and, thus, improves efficiency in the manufacturing process. The lower heat capacity of the square shaped tubing further provides improvements in furnace efficiency since such heat is not wasted in heating the bending ring.

The description of the invention is merely exemplary in nature and, thus, variations that do not depart from the gist of the invention are intended to be within the scope of the invention. Such variations are not to be regarded as a departure from the spirit and scope of the invention.

1. A bending ring for supporting a glass sheet during heating, said bending ring comprising:
a pair of longitudinally extending tubular members being generally square-shaped in cross section;
a plurality of traversely extending tubular members being generally square-shaped in cross section, said plurality of traversely extending tubular members being fixedly coupled to said pair of longitudinally extending tubular members to form a generally rectangular assembly;
a plurality of support brackets generally having an extending portion and a face portion, said extending portion positioned adjacent a first side of one of said pair of longitudinally extending tubular members, said face portion abutting a second side of said one of said pair of longitudinally extending tubular members;
a pair of central stationary members fixedly coupled to said pair of longitudinally extending tubular members via said plurality of support brackets; and
a pair of outboard movable members movably coupled to said pair of longitudinally extending tubular members via said plurality of support brackets.

2. The bending ring according to claim 1, further comprising:
a square-shaped tubular gusset fixedly coupled between at least one of the pair of longitudinally extending tubular member and at least one of said plurality of traversely extending tubular members.

3. The bending ring according to claim 1 wherein said pair of longitudinally extending tubular members and said plurality of traversely extending tubular members are made of a stainless steel having an exterior dimension of approximately 1.25″×1.25″ with a wall thickness of approximately 1/16″.
